(19) United States
(12) Patent Application Publication
(10) Pub. No.: US 2013/0038892 A1
(43) Pub. Date: Feb. 14, 2013

(54) IMAGE PROCESSING DEVICE, IMAGE FORMING DEVICE, AND IMAGE PROCESSING METHOD

(71) Applicant: Naoya MORITA, Kanagawa (JP)

(72) Inventor: Naoya MORITA, Kanagawa (JP)

(73) Assignee: RICOH COMPANY, LTD., Tokyo (JP)

(21) Appl. No.: 13/570,687

(22) Filed: Aug. 9, 2012

(30) Foreign Application Priority Data
Aug. 12, 2011 (JP) 2011-177026

(51) Int. Cl. G06K 15/02; G09G 5/02

(52) U.S. Cl. 358/1.14; 345/596

(57) ABSTRACT

An image processing device analyzes a drawing command read from a memory and performs a halftone processing function to image data. In the image processing device, a drawing command analysis unit analyzes a drawing command, a full set of drawing commands is registered in a drawing command table, and an error processing command is stored in an error processing command storing unit. When the drawing command analysis unit detects a command error indicating that a drawing command read from the memory is not registered in the drawing command table, an error processing executing unit executes the error processing command stored in the error processing command storing unit and performs an error processing function.

### BACKGROUND OF THE INVENTION

1. Field of the Invention

The present disclosure relates to an image processing device which analyzes a drawing command read from a memory and writes, to the memory, image data obtained after a halftone processing function is performed.

2. Description of the Related Art

An image forming device, such as a digital copier or a printer, performs image processing functions to print data received from a PC (personal computer), and outputs the processed data onto a printing medium, such as a copy sheet.

FIG. 1 is a diagram for explaining an image-processing function performed by an image forming device 400 according to the related art. As shown in FIG. 1, the image-processing function performed by the image forming device 400 is divided into steps 1-5, and the steps 1-5 will be described.

Step 1: Print data in a PDL (page description language) format is generated by an application program on a PC 300 using an OS (operating system) and a printer driver therein and the print data (PDL) is written to a memory of the image forming device 400.

Step 2: An application program (software) executed by a CPU 401 of the image forming device 400 analyzes the print data (PDL), generates a drawing command which is described in an intermediate language, and writes the drawing command (intermediate language) to the memory.

Step 3: A drawing device 402 analyzes the drawing command, and writes image data obtained after a halftone processing function (or binarization) is performed to the memory.

Step 4: An encoding device 403 encodes the binary image in accordance with a compression coding algorithm, such as JBIG, and writes the encoded image data to the memory.

Step 5: A decoding device 404 decodes the encoded image data from the memory into raster data corresponding to respective colors of C, M, Y and K, and transmits the raster data to a printer engine 405.

With the needs for increasing the resolution and the colorization and for shortening the printing time, it is demanded that the speed of the above-described image-processing function is increased further. There are several proposals for increasing the speed of the image-processing function. For example, Japanese Laid-Open Patent Publication No. 2006-121437 discloses an image processing device which is aimed at accelerating the image processing function. In this image processing device, the Y width of a halftone pattern of plotting word X width is stored in a halftone pattern memory. The image processing device generates the halftone pattern address value of the halftone pattern memory from the Y value of a horizontal line to be drawn. The halftone pattern from the halftone pattern memory can be efficiently used in the drawing object having the same halftone level, and the image processing speed can be increased.

However, the drawing device in the conventional image processing device is not provided with an error detecting unit to detect an error which may arise when an image processing function is performed. There has been a problem that the software in the drawing device is unable to perform an error processing function that stops the operation of the conventional image processing device upon occurrence of an error.

Recently, it is known that a multi-function image forming device is arranged to include multiple applications to perform multiple image forming functions, including a printer function, a scanner function, a copy function, a fax function, etc., installed therein, and these applications are ready to receive any of respective jobs of these functions. Hence, in the multi-function image forming device, two or more applications may be executed in parallel simultaneously. For example, execution of the copy application is started when the printer application is being executed to perform a printing job. The right to use software and hardware resources in the device when the two or more applications are executed to perform the respective jobs is arbitrated in order to prevent a resource conflict from occurring. However, it is known that there is a possibility that an error of a drawing command may occur, for example, when the control software writes to the memory of the device respective drawing commands for the two or more applications.

The control software uses an address indicated by a pointer when writing a drawing command to the memory. However, there is a possibility that the control software may write the drawing command to a wrong area of the memory which is different from the area (indicated by the address) to which the drawing command is to be written, due to mismatching of the pointer.

As described above, the drawing device in the conventional image processing device is not provided with an error detecting unit to detect an error which may arise when an image processing function is performed. Hence, the drawing device is unable to detect that a halftone processing function is performed as a result of the analysis of an erroneous drawing command written to the memory by the control software, and also unable to detect that the control software has written the drawing command to an un-desired area of the memory different than the predefined areas thereof. As a result, the drawing device will continue to perform the image processing function. In such a case, the image forming device according to the related art will create a printout of an erroneous image.

FIG. 2 is a diagram showing examples of erroneous images. For example, in a case of print data which represents the character “A”, if no error arises, an image of the character “A” as shown on the left side of (a) in FIG. 2 is printed out. On the other hand, if an error arises in the position indicated by the arrow on the right side of (a) in FIG. 2, the print result will become an erroneous image as shown on the right side of (a) in FIG. 2.

Moreover, in a case of print data which represents text, if no error arises, an image of characters and/or signs arranged in accordance with the print data as shown on the left side of (b) in FIG. 2 is printed out. On the other hand, if a certain error arises, the print result will become an erroneous image as shown on the right side of (b) in FIG. 2. In this case, the printed image partially contains erroneous characters and/or signs which are clearly inconsistent with the context of the text. However, the major portion of the printed image contains normal characters and/or signs which are consistent with the context of the text. The erroneous image as shown on the right side of (b) in FIG. 2 is not easily recognized by a user, and the situation in which the user notices the necessity of re-printing of the image may happen later.

### SUMMARY OF THE INVENTION

In one aspect, the present disclosure provides an image processing device which is capable of stopping printing of an erroneous image when an error in a drawing command read from a memory of the image processing device by a drawing device is detected.

In an embodiment which solves or reduces one or more of the above-described problems, the present disclosure provides an image processing device which analyzes a drawing command read from a memory and performs a halftone processing function to image data, the image processing device including: a drawing command analysis unit configured to analyze a drawing command read from the memory; a drawing command table in which a full set of drawing commands is registered; an error processing command storing unit in which an error processing command is stored; an error processing executing unit configured to execute, when the drawing command analysis unit detects a command error indicating that the drawing command read from the memory is not registered in the drawing command table, the error processing command stored in the error processing command storing unit, so that an error processing function is performed.

Other objects, features and advantages of the present disclosure will become more apparent from the following detailed description when read in conjunction with the accompanying drawings.

### BRIEF DESCRIPTION OF THE DRAWINGS

FIG. 1 is a diagram for explaining an image processing function performed by an image forming device according to the related art.

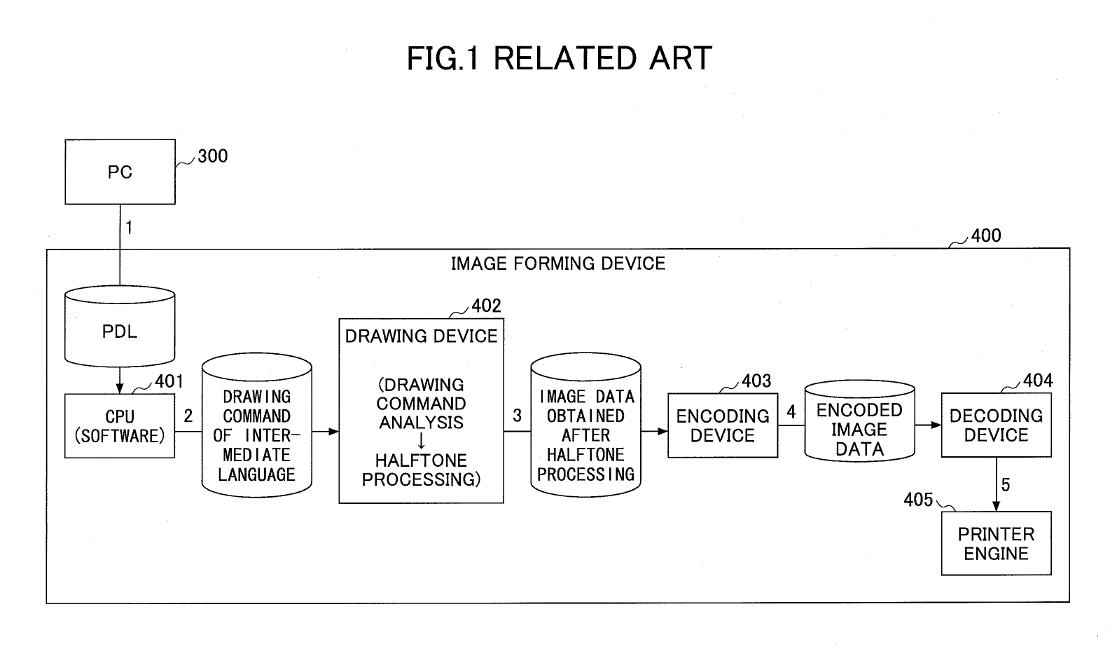

FIG. 2 is a diagram showing examples of erroneous images.

FIG. 3 is a diagram for explaining the functional composition of a drawing device according to an embodiment of the present disclosure.

FIG. 4 is a block diagram of an image forming device according to an embodiment of the present disclosure.

FIG. 5 is a diagram showing the hardware composition of the image forming device of the present embodiment.

FIG. 6 is a diagram for explaining a flow of an image processing function performed by the image forming device of the present embodiment to transfer print data of PDL to a printer engine.

FIG. 7 is a diagram showing an example of a list of drawing commands.

FIG. 8 is a diagram showing a format of a drawing command.

FIG. 9 is a diagram showing examples of error processing commands.

FIG. 10 is a block diagram of the drawing device of the present embodiment.

FIG. 11 is a block diagram showing the functional blocks of the software executed by a CPU.

FIG. 12 is a flowchart for explaining a procedure in which a drawing process is performed by the drawing device of the present embodiment.

FIG. 13 is a diagram showing examples of error processing outputs which are printed when an error is detected by the drawing device.

FIG. 14 is a diagram for explaining the functional composition of a drawing device according to another embodiment of the present disclosure.

FIG. 15 is a block diagram of the drawing device of the present embodiment.

FIG. 16 is a flowchart for explaining a procedure in which a drawing process is performed by the drawing device of the present embodiment.

### DETAILED DESCRIPTION OF THE PREFERRED EMBODIMENTS

A description will be given of embodiments of the present disclosure with reference to the accompanying drawings.

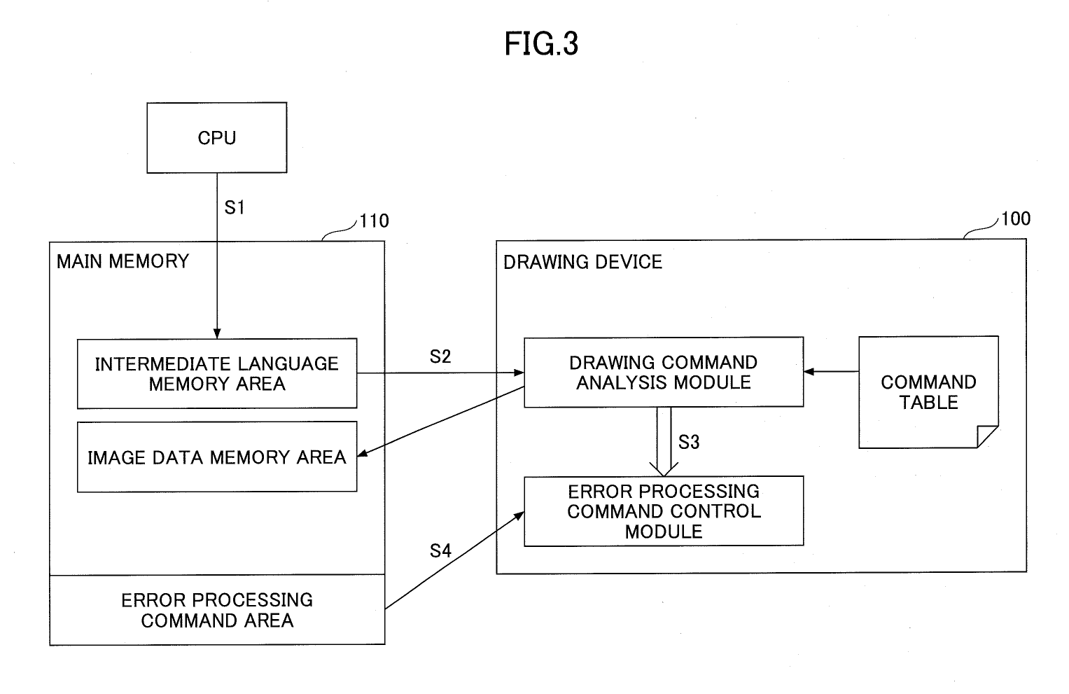

FIG. 3 is a diagram for explaining the functional composition of a drawing device of an embodiment of the present disclosure.

As shown in FIG. 3, the drawing device 100 of this embodiment generally includes a command table, a drawing command analysis module, and an error processing command control module. A main memory 110 generally includes an intermediate language memory area, an image data memory area, and an error processing command area. The following procedure is performed by the drawing device 100 of this embodiment.

Step S1: A control program (software) executed by a CPU analyzes print data described in a PDL (page description language) format and writes a drawing command described in an intermediate language to the intermediate-language memory area of the main memory 110.

Step S2: The drawing device 100 obtains from the CPU an address of the main memory 110 where the drawing command is written. Before analyzing the drawing command, the drawing command analysis module of the drawing device 100 determines whether the drawing command is registered in the command table. Because the kinds of applicable drawing commands are limited, all the applicable drawing commands can be listed and are stored in the command table. If the drawing command does not match with any of the drawing commands of the command table, it can be determined that an error has occurred at a time of writing the drawing command to the intermediate-language memory area of the main memory 110.

Step S3: The drawing command analysis module of the drawing device 100 notifies the error processing command control module of occurrence of an error when it is determined that the drawing command read from the intermediate-language memory area does not match with any of the drawing commands of the command table.

Step S4: The error processing command control module of the drawing device 100 reads an error processing command from the error processing command area of the main memory 110, and executes the error processing command to perform the error processing function so as to print white data or the like, instead of an erroneous image.

In this manner, the drawing device 100 determines whether the drawing command written to the intermediate-language memory area is registered in the command table, and it is possible to detect occurrence of an error. Hence, it is possible to prevent printing of an erroneous image as it is. Upon occurrence of an error, it is possible to take suitable corrective measures, such as return control.

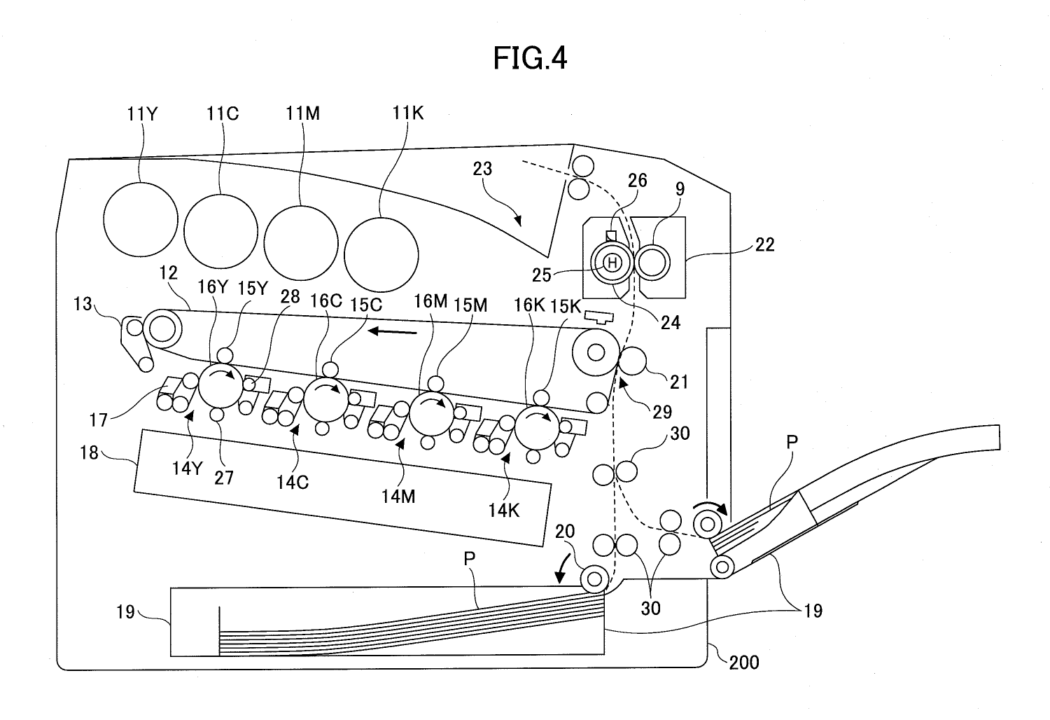

FIG. 4 shows the composition of an image forming device 200 of this embodiment. As shown in FIG. 4, the image forming device 200 generally includes four toner bottles 11Y, 11C, 11M, 11K (which may be collectively referred to as toner bottle 11), four image formation units 14Y, 14C, 14M, and 14K (which may be collectively referred to as image formation unit 14), an optical writing unit 18, an intermediate transfer belt 12, sheet trays 19, and a fixing unit 22.

The optical writing unit 18 takes out an individual main-scanning line data of the image data generated by the drawing device 100 and outputs the line image data to a laser driving part. The laser driving part drives a semiconductor laser by modulating a laser beam according to the line image data so that a photoconductor 16 is emitted by the laser beam. The laser beam emitted from the optical writing unit 18 scans the surface of the cylindrical photoconductor 16 in the axial direction thereof (main scanning direction), and an electrostatic latent image according to the image data is written to the outer surface of the photoconductor 16. The drawing device 100 of this embodiment is arranged to supply image data to the optical writing unit 18.

Each image formation unit 14 forms a toner image of a corresponding color on the intermediate transfer belt 12 respectively. Each image formation unit 14 generally includes a charging part 27, a developing part 28, and a cleaning part 17, which are arranged around a corresponding one of the photoconductors 16Y, 16C, 16M, and 16K (which may be collectively referred to as photoconductor 16) which are rotated in the direction indicated by the arrow in FIG. 4.

The charging part 27 includes a conductive member which is formed in a roller configuration. A bias voltage from a power unit is supplied to the charging part 27 and the charging part 27 uniformly charges the outer surface of the photoconductor 16. The photoconductor 16 is rotated by a motor (not illustrated) at a surface velocity which is the same as that of the intermediate transfer belt 12.

The developing part 28 generates a toner image from the electrostatic latent image on the photoconductor 16 by causing the toner from the toner bottle 11 to adhere to the outer surface of the photoconductor 16.

The intermediate transfer belt 12 is an endless belt which is formed in a loop configuration and made of a substrate of a resin film or a rubber. The intermediate transfer belt 12 is supported on rollers and rotated by the motor which drives the rollers. Four transfer rollers 15Y, 15C, 15M, and 15K are arranged in each photoconductor 16 and the position which faces at the inner circumference surface of the intermediate transfer belt 12.

The intermediate transfer belt 12 and the photoconductor 16K always touch. The intermediate transfer belt 12 and the photoconductors 16Y, 16C, and 16M the connection state and the separated state of which is controlled by a known mechanism (not illustrated).

The transfer roller 15 causes the toner image of each color to be transferred to the intermediate transfer belt 12 by producing a potential difference between the transfer voltage and the power supplied from the power unit.

By transferring the toner images of the respective colors to the intermediate transfer belt 12, a toner image in color is supported on the intermediate transfer belt 12.

The cleaning part 17 removes the toner which remains after the toner image is transferred by the intermediate transfer belt 12 from the photoconductor 16. The cleaning device 13 is disposed at the outer surface side of the intermediate transfer belt 12. The cleaning device 13 cleans the remaining toner and dust after the color toner image is transferred to the sheet medium.

Under the image forming device 200, one of the sheet trays 19 which holds plural copy sheets (print sheets) is arranged. Separation feeding is carried out by the feed roller 20 from the printing sheet of the topmost part in the transfer medium of two or more sheets in the sheet tray 19. The other sheet tray 19 is an open/close-type sheet tray which is arranged on the right-hand side of the image forming device 200, and it is used in order to laminate the transfer medium by which manual bypass is carried out.

The transfer medium by which separation feeding is carried out from the sheet tray 19 or the open/close type sheet tray 19 has a conveying route conveyed, and is conveyed to a nip part 29, the fixing unit 22, and a paper output tray 23. A registration roller 30 is a roller which is intermittently rotated at predetermined timing.

The toner image on the intermediate transfer belt 12 is the timing which reaches the nip part 29, and the registration roller 30 conveys the transfer medium conveyed to the position of the registration roller 30 to the nip part 29. In the process in which the transfer medium passes the nip part 29, a secondary transfer roller 21 transfers the toner image of the intermediate transfer belt top 12 to the transfer medium according to pressure and electrostatic force.

The fixing unit 22 has a fixing roller 24 which equips the interior with a fixing heater 25, and a pressurizing roller 9, applies heat and pressure to the transfer medium to which the toner image is transferred, fuses a toner, and fixes a toner image to the transfer medium. The temperature of the surface of the fixing roller 24 is detected with a thermistor 26. The transfer medium which passed the fixing unit 22 is delivered to the paper output tray 23 allocated in the upper face part of the image forming device 200.

The image forming device 200 using the electrophotographic printing method has been explained. Alternatively, the image forming device 200 may be arranged to use the inkjet printing method to generate the image data by which a halftone processing function is carried out from the drawing command, the drawing device 100 of this embodiment is applicable to the image forming device 200 of the inkjet printing method in FIG. 4.

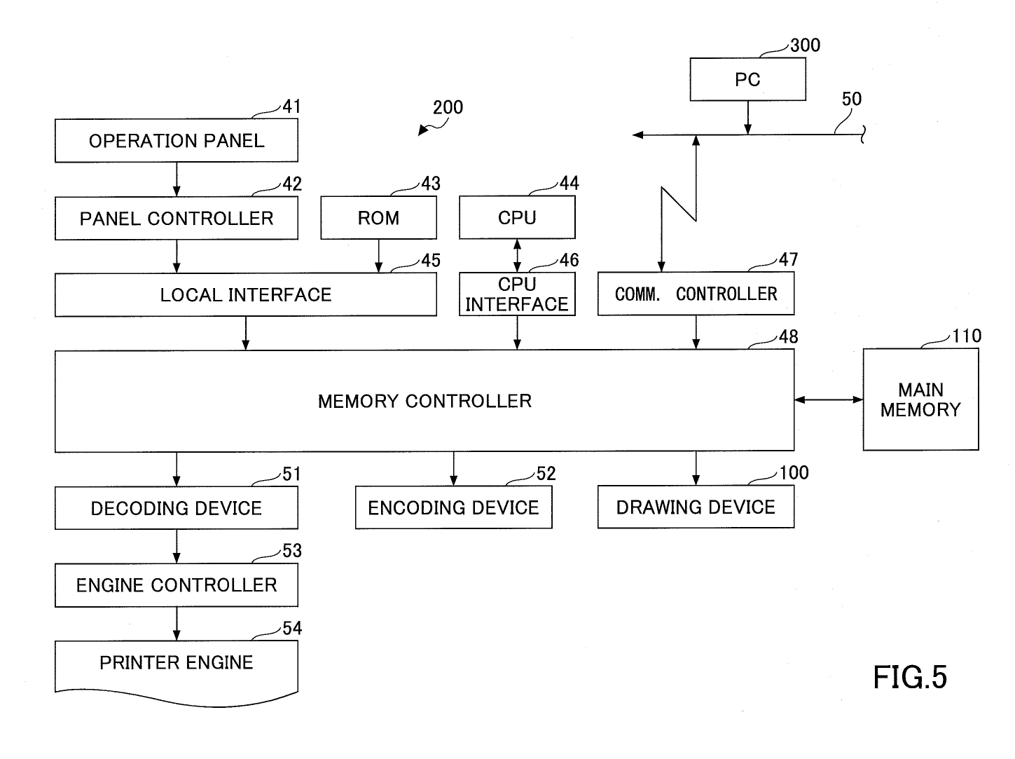

FIG. 5 shows the hardware composition of the image forming device 200. As shown in FIG. 5, the CPU 44, the printer engine 54, the drawing device 100, and the main memory 110 are connected to the memory controller 48 which performs access to the main memory 110.

In addition, the operation panel 41, the encoding device 52, and the communication controller 47 are connected to the main memory 110.

The operation panel 41 is a UI (user interface) which displays the control unit in which a user operates the image forming device 200, and the screen containing a menu.

The operation panel 41 receives the input operation from a user and notifies it to the panel controller 42. The panel controller 42 switches the screen displayed on the operation panel 41 in order of the changes defined beforehand according to operation of the user.

The panel controller 42 notifies the input operation from the user which the operation panel 41 received to the local interface 45.

The local interface 45 notifies the contents of operation to the CPU 44 by using an interrupt.

The ROM 43 is connected to the local interface 45. The boot loader, for reading the main program from the HDD (not illustrated) to the ROM 43 at the time of starting of the image forming device 200 and writing in the main memory 110, and other static parameters are stored. The main program may also be stored in the ROM 43.

The CPU 44 executes the main program and controls the whole image forming device 200. The CPU 44 of this embodiment receives a notice from the drawing device 100 to the processing which analyzes the print data of PDL and writes a drawing command in the main memory 110, and upon occurrence of an error, the CPU 44 performs a stopping and restarting process of printing.

The CPU interface 46 separates the memory controller 48 from the CPU 44, and when the CPU 44 and the memory controller 48 communicate, it manages a part for the mutual communication parts so that the CPU 44 and the memory controller 48 may not be in a waiting state by waiting for a response.

The encoding device 52 encodes the image data stored in the main memory 110 in accordance with the known encoding method, such as JBIG, and writes the encoded data to the encoded page memory area of the main memory 110 via the memory controller 48.

The decoding device 51 reads and decodes the code data which is encoded by the encoding device 52 and written in via the memory controller 48.

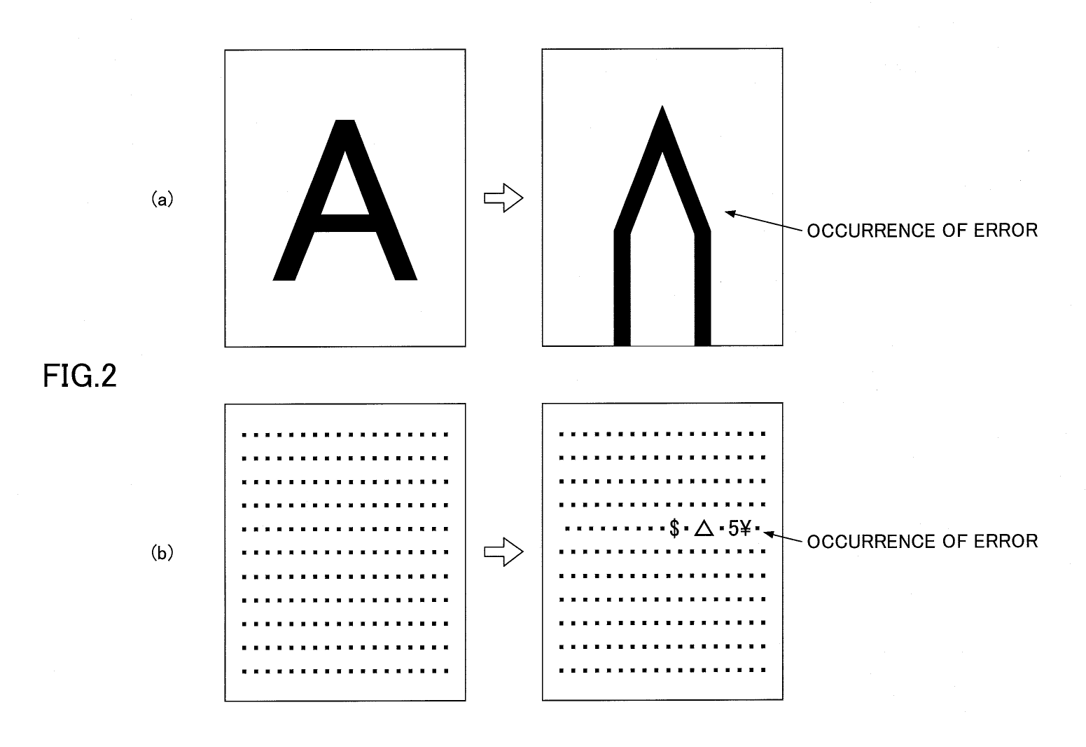

The engine controller 53 is connected to the decoding device 51, and the engine controller 53 receives the image data decoded by the decoding device 51, and transmits them to the printer engine 54. The engine controller 53 controls the optical writing unit 18 of FIG. 2 according to image data.

The memory controller 48 performs writing of various kinds of data, and read-out between the local interface 45, the CPU interface 46, the communication controller 47, the decoding device 51, the encoding device 52, the drawing device 100, and the main memory 110, arbitrating an access request.

The main memory 110 will be described later. The print data of PDL, drawing commands, image data, code page data, the main program, etc. are stored in the main memory 110.

The drawing device 100 writes the image data by which binarization is carried out by analyzing a drawing command and performing halftone processing function to image data in the main memory 110. The drawing device 100 will be described later.

The image forming device 200 is connected to the PC 300 via a network 50. The communication controller 47 which is connected with the network 50 receives the print data of PDL from the PC 300, and writes the print data to the main memory 110.

The communication controller 47 is, for example, an Ethernet card. The network 50 may be any of a LAN (or VLAN) which exceeds neither a router nor L3 switch, a WAN in which LANs are connected via a router or L3 switch, and a network containing the Internet.

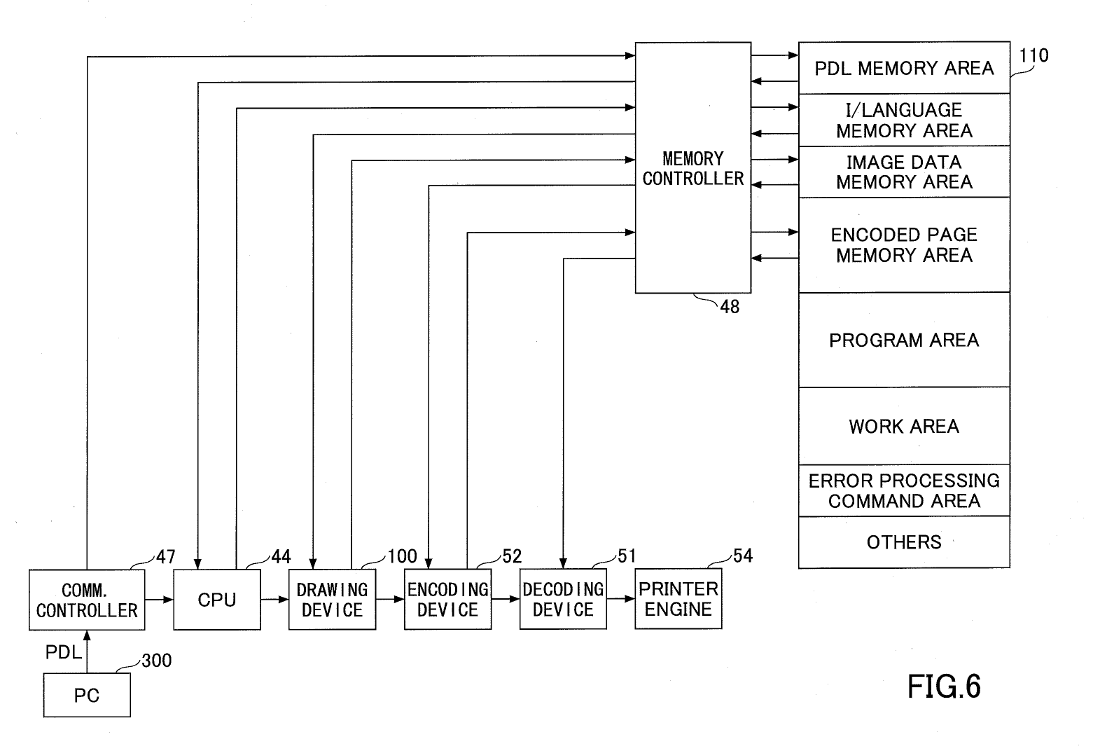

FIG. 6 is a diagram for explaining a flow of an image processing function performed by the image forming device 200 to transfer print data of PDL to the printer engine 54. For each step of the image processing function, the image forming device 200 accesses the main memory 110 and performs the step.

As shown in FIG. 6, the main memory 110 is divided beforehand into a number of areas. For example, the main memory 110 is made of an SDRAM. The memory controller 48 accesses data of one kind for one step, and then it is desired to store data items of the same kind in successive areas of the memory, in order to improve the efficiency of data accessing. For this reason, the data items are stored in predetermined areas of the main memory 110 in principle (if no error arises).

For example, the main memory 110 includes a PDL memory area, an intermediate-language memory area, an image data memory area, an encoded page memory area, a program area, a work area, and other areas. In the case of this embodiment, the main memory 110 further includes an error processing command area within the other areas which are prepared to provide a margin. This error processing command area is to store a command to be executed by the drawing device 100 when an error is detected by the drawing device 100.

In the program area, the main program which is executed by the CPU 44 is stored. In the work area, the intermediate processing result presented by the CPU 44 is stored.

When an application program running on a PC 300 is to perform a printing job, a printer driver of the PC 300 generates print data described in PDL (page description language) and transmits the print data to the image forming device 200 via the network 50. The communication controller 47 of the image forming device 200 receives the print data of PDL and stores the print data in the PDL memory area of the main memory 110. The memory controller 48 notifies the CPU 44 of the reception of the print data, the start address of the stored print data, and the size of the stored print data by outputting an interrupt signal to the CPU 44.

The CPU 44 is executing the main program, and if the reception of the print data is detected, the CPU 44 starts printing of the print data. First, the print data of PDL is read from the PDL memory area of the main memory 110 and analyzed, and print data described in the intermediate language (a drawing command) is generated. The CPU 44 stores the generated drawing command in the intermediate-language memory area of the main memory 110. The CPU 44 notifies the drawing device 100 of the generation of the drawing command, the start address of the drawing command, and the size of the drawing command.

The drawing device 100 reads the drawing command from the main memory 110, analyzes the drawing command, and generates image data. The drawing device 100 writes the image data to the image data memory area of the main memory 110. The image data memory area has a memory space which is equivalent to a band size when image data of 1 page is equally divided into 8-16 portions in the sub-scanning direction.

Drawing commands will be described later. A rectangle, a triangle, etc. are drawn by execution of drawing commands. A halftone processing function is performed by execution of a drawing command and binary image data is generated. The drawing device 100 notifies the CPU 44 of the state of the processing by using a status register.

The CPU 44 monitors progress of the writing of the image data to the main memory by using the status register, and requests the encoding device 52 to perform encoding of the image data. The encoding device 52 reads the image data from the image data memory area of the main memory 110, encodes the image data according to the binary image compression algorithm, such as JBIG, and stores the encoded image data in the encoded page memory area of the main memory 110. When the requested encoding of the image data is finished, the encoding device 52 notifies the CPU 44 of the end of the encoding. The encoded page memory area of the main memory 110 has a storage capacity larger than a storage capacity of one-page image data or one-band image data.

After encoding of one-page image data is finished, the CPU 44 requests the decoding device 51 to perform decoding of the encoded image data. The decoding device 51 reads the encoded image data of one page for each band from the main memory 110, decodes the encoded image data, and transmits the resulting print data to the engine controller 53. Hence, the printer engine 54 is controlled by the engine controller 53 so that the printer engine 54 performs printing of the print data.

### Drawing Command List

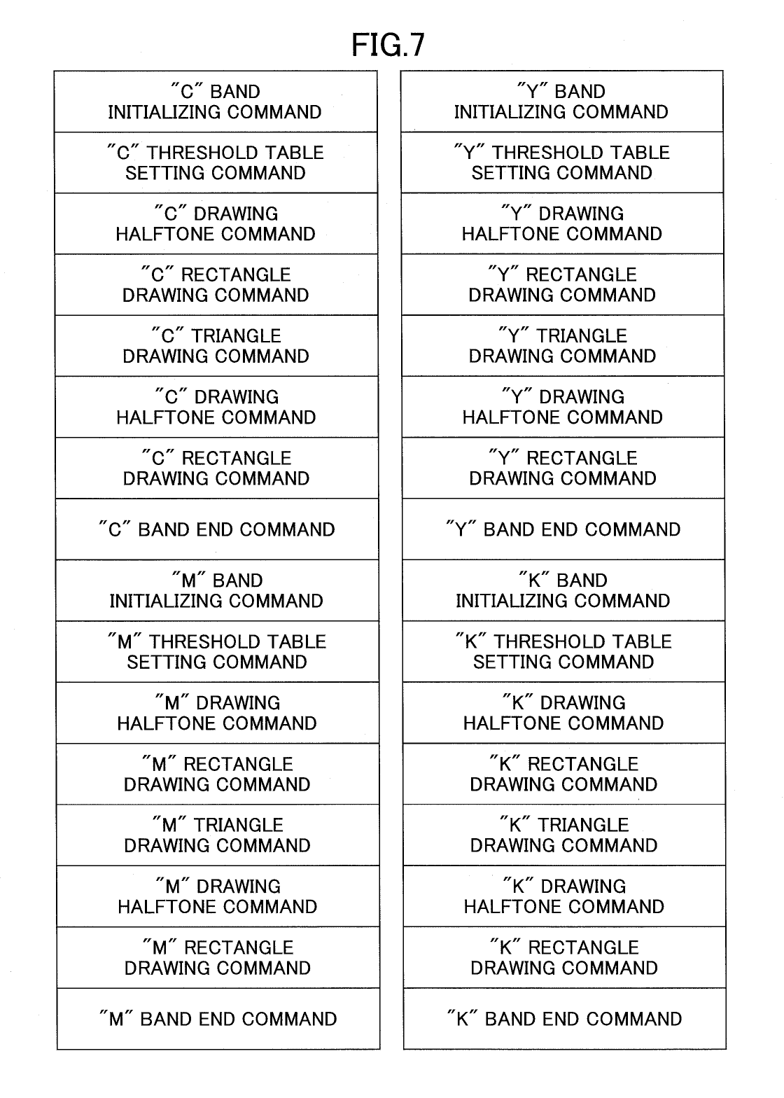

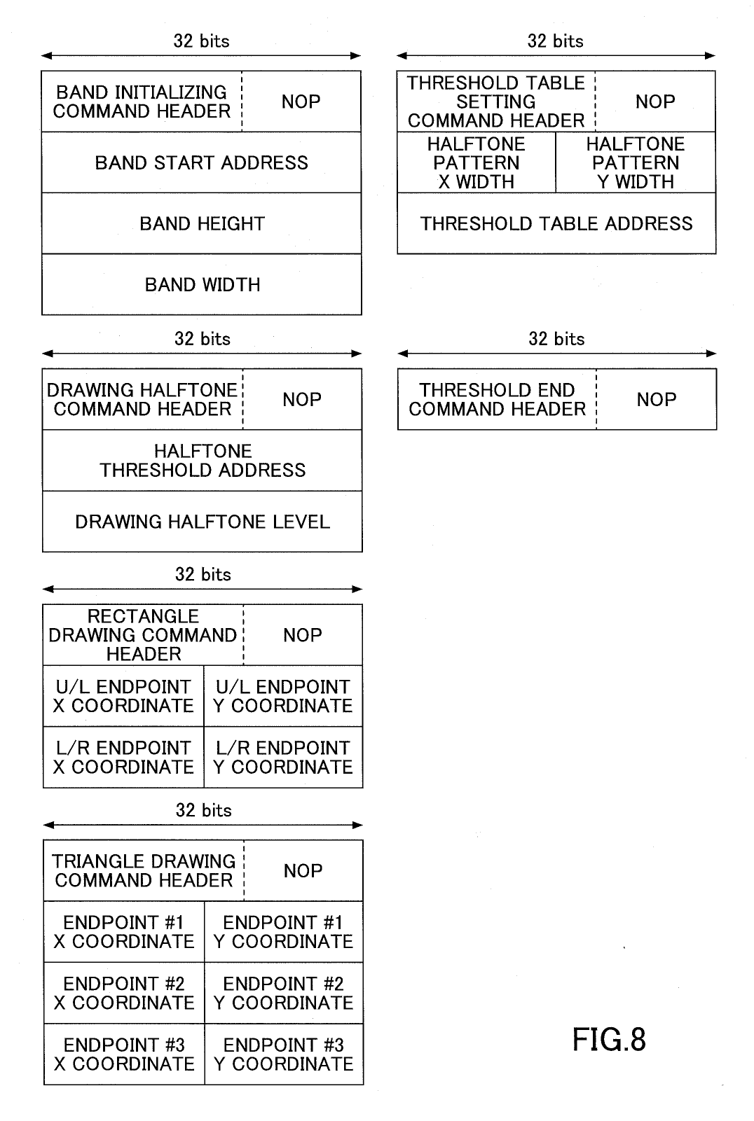

FIG. 7 shows an example of a list of drawing commands. FIG. 8 shows an example of a format of a drawing command. In a case of a 4-color printer, four color toner images are overlapped to generate a color image, and a set of drawing commands is prepared for each of four colors C, M, Y and K.

As shown in FIGS. 7 and 8, a band initializing command defines a start address of a band and a height of the band. One band initializing command has a command length of 4×32 bits and includes a band initializing command header, a band start address, a band height and a band width. In FIG. 8, “NOP” is the abbreviation of no operation.

A drawing halftone command defines a halftone threshold address and a drawing halftone level. One drawing halftone command has a command length of 3×32 bits and includes a halftone threshold address and a drawing halftone level.

A threshold table setting command defines an X width and a Y width of a halftone pattern and an address of a threshold table for each pixel. One threshold table setting command has a command length of 3×32 bits and includes a threshold table setting command header, a halftone pattern X width, a halftone pattern Y width, and a threshold table address.

A rectangle drawing command defines coordinates of an upper left endpoint of a specified rectangle and coordinates of a lower right endpoint thereof. One rectangle drawing command has a command length of 3×32 bits and includes an upper left endpoint X-coordinate, an upper left endpoint Y-coordinate, a lower right endpoint X-coordinate, and a lower right endpoint Y-coordinate.

A triangle drawing command defines respective coordinates of three points of a specified triangle. One triangle drawing command has a command length of 4×32 bits and includes 3 sets of endpoint X-coordinates and endpoint Y-coordinates.

A band end command defines an end of a band. One band end command has a command length of 1×32 bits and includes a band end command header.

In the command table of this embodiment, the command headers of all the drawing commands which can be analyzed by the drawing device 100 are registered. With respect to one band, a first one of a group of drawing commands is a band initializing command, and a final one of the group of drawing commands is a band end command.

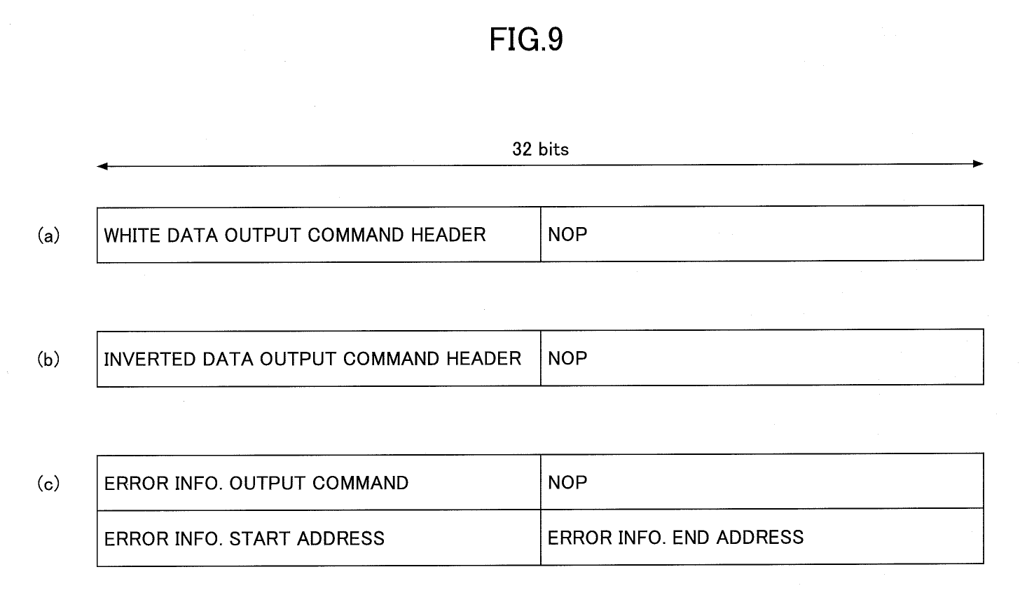

FIG. 9 is a diagram showing examples of error processing commands. For example, error processing command includes the following three commands.

### (1) White Data Output Command

An example of a white data output command is shown in (a) of FIG. 9. This white data output command is a command to output white data as the band after an error is detected. One white data output command has a command length of 1×32 bits.

### (2) Inverted Data Output Command

An example of an inverted data output command is shown by (b) in FIG. 9. This inverted data output command is a command to output inverted data (black or white) of the band for which a drawing process is being performed. One inverted data output command has a command length of 1×32 bits.

### (3) Error Information Output Command

An example of an error information output command shown in (c) of FIG. 9. This error information output command is a command to output an error message to the band for which a drawing process is being performed. One error information output command has a command length of 2×32 bits and includes an error information start address, and an error information end address. The error information start address is a start address of the drawing command of the error message stored in the error processing command area, and the error information end address is an end address of the drawing command of the error message.

### Drawing Device

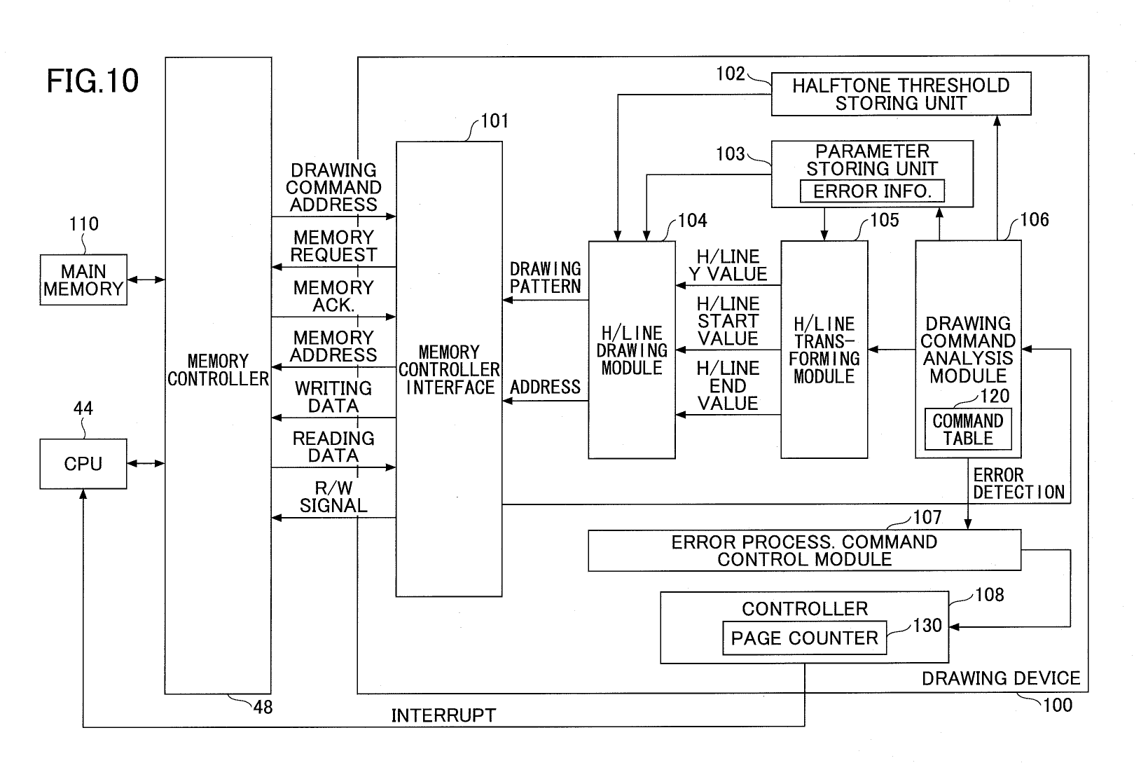

FIG. 10 is a diagram showing the composition of the drawing device 100. The drawing device 100 generally includes a controller 108, an error processing command control module 107, a drawing command analysis module 106, a horizontal line transforming module 105, a horizontal line drawing module 104, a parameter storing unit 103, a halftone threshold storing unit 102, and a memory controller interface 101.

The memory controller interface 101 is an interface which is provided between the memory controller 48 and the drawing device 100. The address of a drawing command is notified to the memory controller interface 101 by the CPU.

When reading print data of PDL from the main memory 110, the memory controller interface 101 outputs a memory request to the memory controller 48. In the memory controller 48, the memory access is arbitrated. If the state in which the drawing device 100 can access the main memory 110 is reached, the memory controller 48 returns a memory acknowledgement to the memory controller interface 101.

The memory controller interface 101 designates a R/W signal as (R), outputs the R/W signal to the memory controller 48, and outputs the memory address of the print data of PDL to the memory controller 48.

The memory controller 48 reads the print data of PDL from the main memory 110 at the address specified and outputs the print data to the memory controller interface 101.

When writing image data to the main memory 110, the memory controller interface 101 outputs a memory requests to the memory controller 48. In the memory controller 48, the memory access is arbitrated. When the state in which the drawing device 100 can access the main memory 110 is reached, the memory controller 48 returns a memory acknowledge to the memory interface.

The memory controller interface 101 designates an R/W signal as (W), outputs the R/W signal to the memory controller 48, and outputs the memory address of image data to the memory controller 48. The memory controller 48 writes the image data to the main memory 110 at the address specified.

The controller 108 controls the operation of the entire drawing device 100. In this embodiment, when the drawing command analysis module 106 detects an error, the controller 108 interrupts the CPU 44 and sends a notification of the error to the CPU 44.

The controller 108 includes a page counter 130. The page counter 130 counts the number of bands (a page number) with which the drawing process is performed. Every time the drawing process of image data for a predetermined number of bands which is equivalent to one page is completed, the page counter 130 increments the page number. Thereby, it is possible to identify a page with which an error has occurred from the page number counted by the page counter 130.

The drawing command analysis module 106 analyzes the drawing command which is received from the main memory 110 by the memory controller interface 101, and performs a processing function according to the drawing command.

When a band initializing command is received, the drawing command analysis module 106 stores a band start address, a band height and a band width in the parameter storing unit 103.

When a drawing halftone command is received, the drawing command analysis module 106 stores a drawing halftone level in the parameter storing unit 103, and outputs the drawing halftone level to the halftone threshold storing unit 102 indicated by the halftone threshold address.

The horizontal line drawing module 104 reads the halftone threshold from the halftone threshold storing unit 102 and performs binarization by using the drawing halftone level.

When a threshold table setting command is received, the drawing command analysis module 106 stores the X width and the Y width of a halftone pattern into the parameter storing unit 103, reads the threshold table in the work area of the main memory 110 indicated by the threshold table address, and writes the threshold table to the halftone threshold storing unit 102.

When a rectangle drawing command header is received, the drawing command analysis module 106 outputs the rectangle drawing command, the upper left X-coordinate and Y-coordinate of the rectangle and the lower right X-coordinate and Y-coordinate of the rectangle to the horizontal line transforming module 105.

When a triangle drawing command header is received, the drawing command analysis module 106 outputs the triangle drawing command and the coordinates of three endpoints of the triangle to the horizontal line transforming module 105.

When a band end command is received, the drawing command analysis module 106 ends the drawing process of the band.

In order to determine whether the received drawing command is proper, the drawing command analysis module 106 includes the command table 120. In the command table 120, respective command headers of a full set of applicable drawing commands which can be analyzed by the drawing device 100 are registered. The command table 120 is stored in the ROM 43 or a HDD (which is not illustrated). For example, in an initialization process at the time of starting of the image forming device 200, the main program writes the command table 120 to the register of the drawing command analysis module 106.

The horizontal line transforming module 105 receives a drawing command from the drawing command analysis module 106, converts the drawing command into a horizontal line, and outputs the horizontal line Y value, the horizontal line start point value, and the horizontal line end point value (which are the parameters of the horizontal line) to the horizontal line drawing module 104.

The horizontal line drawing module 104 draws a horizontal line based on the parameters of the horizontal line received from the horizontal line transforming module 105. The horizontal line drawing module 104 reads the halftone threshold from the halftone threshold storing unit 102, performs binarization by the drawing halftone level, and generates a halftone pattern. An AND operation of the halftone pattern and the drawing mask of the horizontal line specified by the parameters is performed to generate a drawing pattern. This drawing pattern serves as image data.

The drawing command analysis module 106 determines whether the drawing command received at the memory controller interface 101 is registered in the command table 120 as one of the analyses of a drawing command. When the drawing command read from the main memory 110 is not registered in the command table 120, the error detection is notified to the error processing command control module 107. When the drawing command read from the main memory 110 is not registered in the command table 120, the drawing command analysis module 106 stores error information in the parameter storing unit 103. For example, the error information includes at least the following items: the drawing command with which the error is detected; the address of the intermediate-language memory area; and the kind of error (in this case, a command error).

Because the error information is stored, the CPU 44 can record what kind of error has occurred in the HDD, by reading the error information. From the kind of error recorded, it is possible to detect later the kind of the error.

When the notice of error detection is received, the error processing command control module 107 reads an error processing command from the error processing command area of the main memory 110, and performs the error processing function.

### (1) White Data Output Command

When a white data output command is read, the error processing command control module 107 sets the whole band or the portion of the band after the error detection to white pixels. Specifically, in the former case, white pixels “1” are overwritten to the whole band including the image data already written in the image data memory area of the main memory 110. In the latter case, white pixels “1” are written to the band portion from the final end of the image data already written to the image data memory area of the main memory 110 to the address equivalent to the band height.

### (2) Inverted Data Output Command

When an inverted data output command is read, the error processing command control module 107 inverts the black and white pixels of the whole band or the portion of the band at the location of the error detection. Specifically, in the case of the former, the drawing command analysis module 106 continues the writing of the image data to the image data memory area and the analysis of the drawing command even after the error detection. If a band end command header is read by the drawing command analysis module 106, the error processing command control module 107 sequentially reads out the image data from the image data memory area, and inverts a white pixel “1” into a black pixel “0” or inverts a black pixel “0” into a white pixel “1”, respectively.

In the case of the latter, the error processing command control module 107 sequentially reads out the image data (or the image data already written to the image data memory area of the main memory 110) from the image data memory area, and inverts a white pixel “1” to a black pixel “0” or inverts a white pixel “0” to a black pixel “1”, respectively. White pixels “1” are written to the remaining portion of the band after the location of the error detection.

### (3) Error Information Output Command

When an error information output command is read, the error processing command control module 107 reads the drawing command from the error information start address, and sends a drawing processing request to the drawing command analysis module 106. The drawing command is read from the error information start address to the error information end address, and the horizontal line transforming module 105 and the horizontal line drawing unit 104 perform the drawing processing function so that an error message is drawn.

When the error processing is finished, the error processing command control module 107 notifies the controller 108 of the end of the error processing. The controller 108 interrupts the CPU 44 and notifies the CPU 44 of the error occurrence.

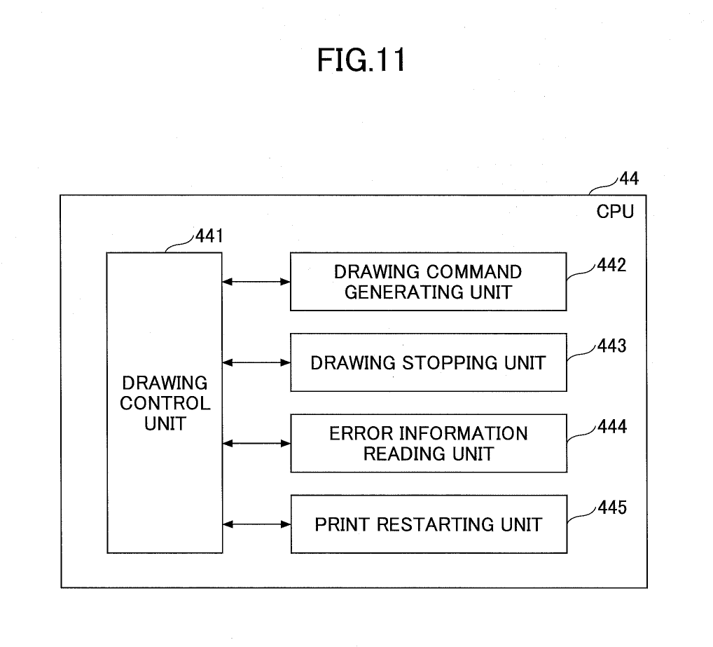

FIG. 11 shows the functional blocks of the software which is executed by the CPU 44. As shown in FIG. 11, the software executed by the CPU 44 generally includes a drawing control unit 441, a drawing command generation unit 442, a drawing stopping unit 443, an error information reading unit 444, and a print restarting unit 445.

The drawing control unit 441 controls a series of processing functions from printing of print data of PDL to outputting of image data. Specifically, if print data of PDL is written to the main memory 110, the drawing control unit 441 starts performing the printing function.

First, the drawing control unit 441 requests processing of the drawing command generating unit 442. The drawing command generating unit 442 analyzes the print data of PDL stored in the main memory 110, generates a drawing command, and writes the drawing command to the main memory 110. The drawing command generating unit 442 requests creation of image data of the drawing device 100, if the print data of the intermediate language in the amount larger than the band width is generated.

Thereafter, the drawing control unit 441 monitors progress of the drawing processing function of the drawing device 100 by using the status register, and causes the drawing command generating unit 442 to update the intermediate-language memory area, or requests the encoding device 52 to perform encoding of the image data. After reading of all the print data of PDL, generation of the drawing command, generation of image data, encoding and decoding and printing of image data are completed, the drawing control unit 441 terminates the process.

The drawing control unit 441 causes the drawing stopping unit 443 to stop the drawing process, if the notice of error detection is received from the drawing device 100. The drawing stopping unit 443 stops the drawing processing function by setting a predetermined port of the drawing device 100 to H level or by writing a stop command to the controller of the drawing device 100.

The drawing control unit 441 requests the error information reading unit 444 to read the error information in the drawing device 100, if the notice of error detection is received from the drawing device 100. The error information reading unit 444 reads the error information from the parameter storing unit 103 of the drawing device 100, and records the error information in a nonvolatile memory such as a HDD. Even when the power of the image forming device 200 is turned off or on, the error information can be held.

The drawing control unit 441 requests the print restarting unit 445 to restart the printing process, if the error information reading unit 444 reads the error information. The print restarting unit 445 receives the page number of the page with which the error is detected, from the controller 108 of the drawing device 100, and notifies the page number to the drawing control unit 441. The drawing control unit 441 causes the drawing command generating unit 442 to generate a drawing command again from the print data of PDL on the page which the error is detected. Hence, the printing job is restarted from the page with which the error is detected.

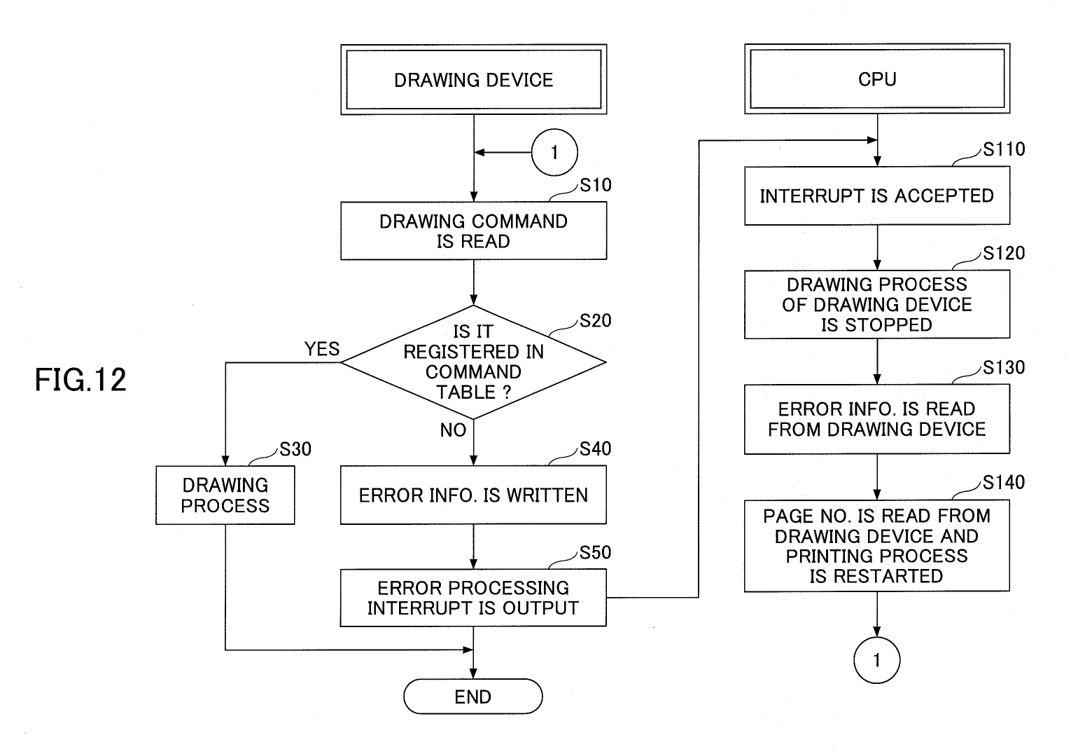

FIG. 12 is a flowchart for explaining a procedure in which a drawing process is performed by the drawing device of this embodiment.

As shown in FIG. 12, the drawing device 100 reads a drawing command from main memory 110 (S10). In this case, one drawing command may be read, or two or more drawing commands may be read collectively. When plural drawing commands are read, the drawing commands are queued to the buffer (not illustrated).

The drawing command analysis module 106 determines whether the read drawing command is registered in the command table 120 (S20). When the read drawing command is registered in the command table 120 (YES of S20), the drawing command analysis module 106 analyzes the drawing command and performs the normal processing function (S30).

On the other hand, when the read drawing command is not registered in the command table 120 (NO of S20), the drawing command analysis module 106 writes error information to the parameter storing unit 103 (S40). The drawing command analysis module 106 notifies the error detection to the error processing command control module 107.

The error processing command control module 107 reads an error processing command from the main memory 110 and performs the error processing function (S50). The error processing command executed in this step may be one of a white data output command, an inverted data output command, and an error information output command. Alternatively, a suitable combination of these output commands may be executed. For example, the error information output command is executed after the white data output command is executed.

In this step S50, the error processing command control module 107 notifies the error detection to the controller 108, and the controller 108 interrupts the CPU 44. Thereafter, operation of the drawing device 100 is controlled by the CPU 44.

The CPU 44 operates the drawing stopping unit 443 by an interrupt (S110). The drawing stopping unit 443 stops the drawing processing function of the drawing device 100 (S120).

Even if the interruption of the error detection takes place in the middle of one page, the CPU 44 performs the printing in the range where the image data is obtained. The drawing control unit 441 requests encoding of image data by the encoding device 52 and after the encoding is finished, the drawing control unit 441 requests decoding of the image data by the decoding device 51, so that the image data is printed on a printing sheet.

Subsequently, the error information reading unit 444 reads the error information from the drawing device 100 (S130). The CPU 44 stores the error information onto the HDD (not illustrated) or the like.

The print restarting unit 445 reads the page number from the drawing device 100 and restarts the printing process (S140). Namely, the drawing command generating unit 442 generates a drawing command again from the print data of PDL of the page with which the error is detected. The drawing stopping unit 443 cancels the halt of the drawing processing function by the drawing device 100. Thereby, when written in main memory, printing is resumed from the page which the error produced.

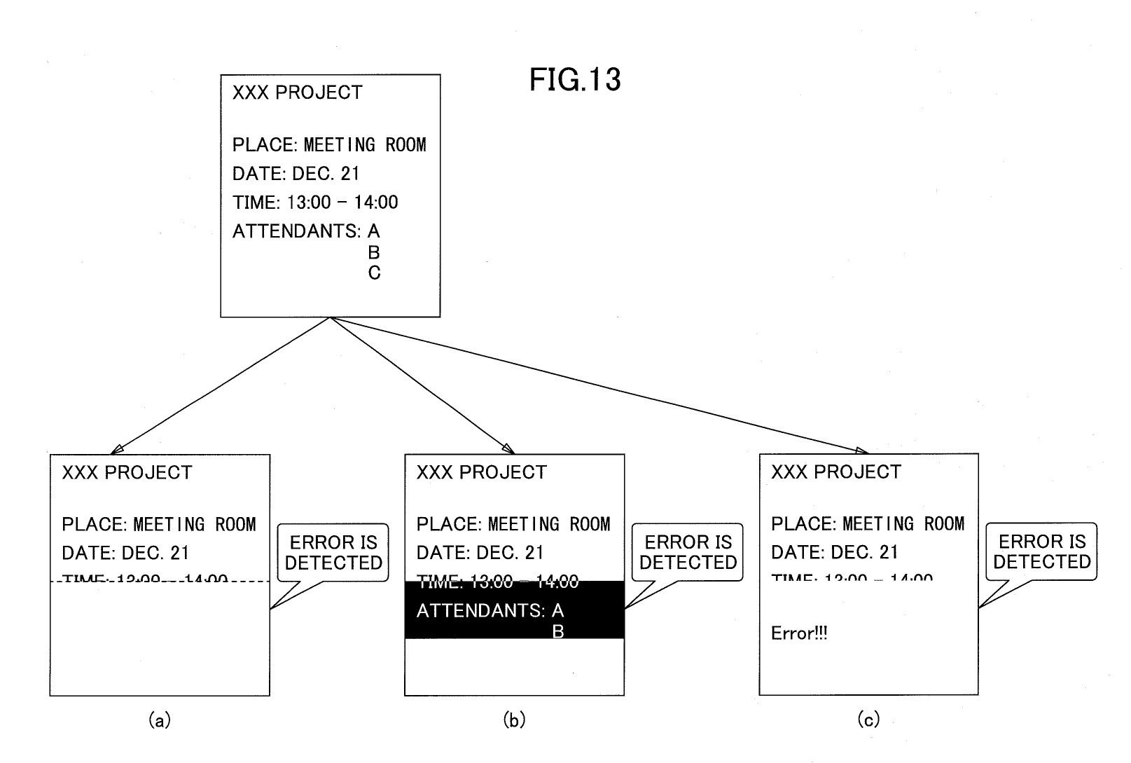

FIG. 13 is a diagram showing examples of error processing outputs which are printed when an error is detected by the drawing device 100. An example of an error processing output by a white data output command is shown in (a) of FIG. 13, an example of an error processing output by an inverted data output command is shown in (b) of FIG. 13, and an example of an error processing output by an error information output command is shown in (c) of FIG. 13.

When the error processing command is the white data output command, no image data is printed with respect to the band with which the error is detected (or white data is printed for the band of concern).

When the error processing command is the inverted data output command, the inverted black and white pixels of the band with which the error is detected are outputted. In the example (b) of FIG. 13, the user can easily recognize that an error arises.

When the error processing command is the error information output command, an error message is printed with respect to the band with which the error is detected. In the example (c) of FIG. 13, the word “Error” is printed as the error message. Any other error message may be used if the error message clearly indicates occurrence of an error. Alternatively, an error code such as “1234” may be printed instead. In this case, if the user informs the error code to the dealer of image forming device 200 or the support center, the support center can easily detect what kind of error has occurred.

As explained above, the drawing device 100 of this embodiment determines whether the drawing command read from the intermediate-language memory area of the memory is registered in the command table 120, and can easily detect occurrence of an error. When occurrence of an error is detected, the image to be formed on a printing sheet is controlled and the printing job is suspended, and the user can easily recognize that an error has occurred. Furthermore, error information may be printed, and it is possible to easily detect what kind of error has occurred. The printing job may be restarted from the page with which the error is detected.

As in the foregoing embodiment, in many cases, when an error arises in the drawing device 100, the drawing command which the CPU 44 writes to the intermediate-language memory area differs from the originally defined drawing command (command error). However, there is another exceptional case. Although the drawing command is to be written to the intermediate-language memory area of the memory, there may be the case in which the CPU 44 writes the drawing command to another memory area (for example, the PDL memory area or the encoded page memory area). For example, when the pointer accessed by the CPU 44 points to a wrong address, the address of the main memory 110 to which the CPU 44 writes the drawing command becomes an unexpected address. If the drawing command is written outside the intermediate-language memory area of the main memory (address error), there is a possibility that other data of the main memory is destroyed by the drawing command and an erroneous image may be printed.

Next, a drawing device 100 of another embodiment of the present disclosure which is arranged to detect that the CPU 44 has written a drawing command outside the intermediate-language memory area will be described.

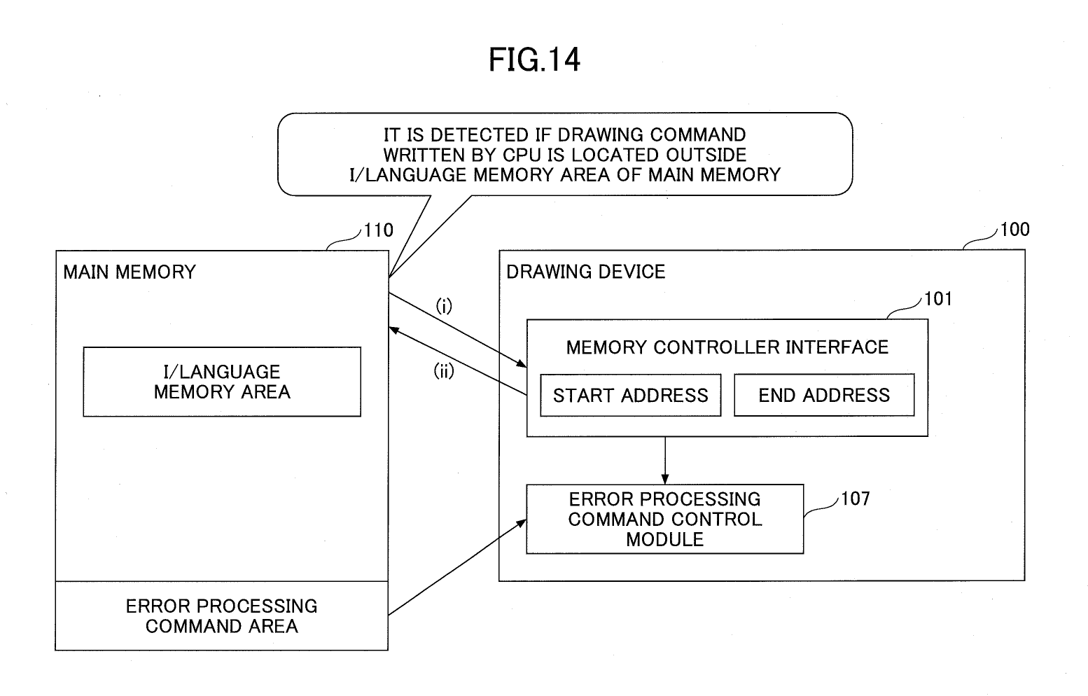

FIG. 14 is a diagram for explaining the functional composition of the drawing device 100 of this embodiment. The intermediate-language memory area is fixed in the main memory 110, and the start address and the end address of the intermediate-language memory area are set to the drawing device 100. Hence, the drawing device 100 can determine whether the drawing command is written to the intermediate-language memory area.

For example, in an initialization process at the time of starting of the image forming device 200, the main program sets the start address and the end address of the intermediate-language memory area to the memory controller interface 101.

As described in the foregoing, when the CPU 44 requests the drawing device 100 to perform the analysis of a drawing command, the CPU 44 notifies the start address of the drawing command. Hence, (i) The memory controller interface 101 can detect whether the drawing command is written outside the intermediate-language memory area, by checking that the start address of the drawing command is located within the range of the start address and the end address of the intermediate-language memory area. (ii) The memory controller interface 101 can detect whether the drawing command is written outside the intermediate-language memory area, based on whether the memory address output to the memory controller 48 is within the intermediate-language memory area.

The memory controller interface 101 reads a drawing command which starts from the start address of the drawing command which the CPU 44 notified to the drawing device 100 and ends at the band end command header. Therefore, the memory controller interface 101 can detect occurrence of an address error, based on whether the memory address output to the memory controller 48 is within the intermediate-language memory area. In this case, every time the memory controller interface 101 requests the memory controller 48 to read the memory, it is possible to determine whether an error has occurred or not.

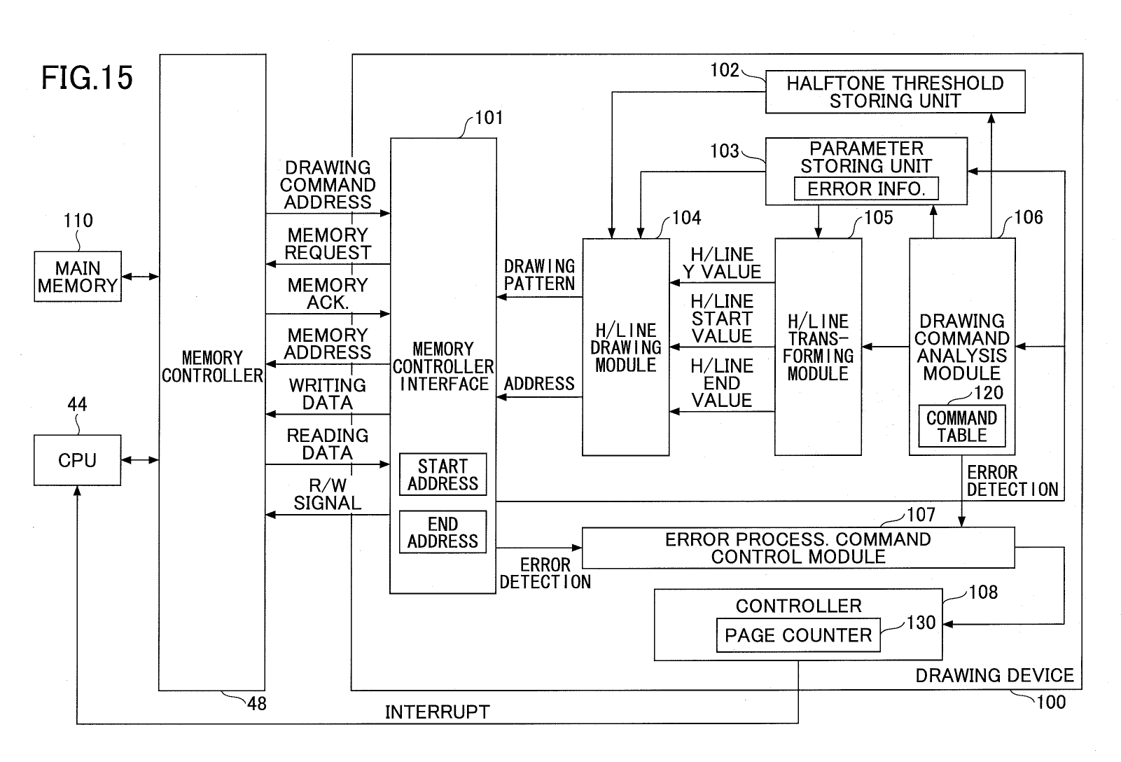

FIG. 15 is a block diagram of the drawing device 100 of this embodiment. In FIG. 15, the elements which are the same as corresponding elements in FIG. 10 are designated by the same reference numerals, and a description thereof will be omitted.

The drawing device 100 of FIG. 15 is basically the same as the drawing device 100 of FIG. 10, and differs from the latter in that the memory controller interface 101 in which the start address and the end address of the intermediate-language memory area are stored, and the memory controller interface 101, the error processing command control module 107 and the parameter storing unit 103 are interconnected.

When occurrence of an error is detected, the memory controller interface 101 stores error information into the parameter storing unit 103. The error information includes at least the following items: the addresses of an intermediate-language memory area; and the kind of the error (in this case, an address error).

Because the error information is stored, it is possible for the CPU 44 to record what kind of error has occurred, by reading the error information. From the kind of error recorded, the support center can detect, at the time of analysis, whether the error of concern is an address error detected by the memory controller interface 101 or a command error detected by the drawing command analysis module 106.

If an error is detected, the memory controller interface 101 notifies the error detection to the error processing command control module 107.

The error processing command control module 107 reads an error processing command from the error processing command area of the main memory 110, and performs the error processing function. The error processing function is the same as that of the previous embodiment of FIG. 10 (the three commands (1)-(3) above).

However, in order to determine the kind of error from the printing sheet, the error processing function may be changed between the command error and the address error. For example, in the case of the command error, the error processing function is performed by executing the command (1), and in the case of the address error, the error processing function is performed by executing the command (2). Alternatively, the error processing function may be performed by executing the command (3) for both the command error and the address error. In such a case, the error message is changed to indicate either the command error or the address error. Hence, the support center can easily detect what kind of error has occurred.

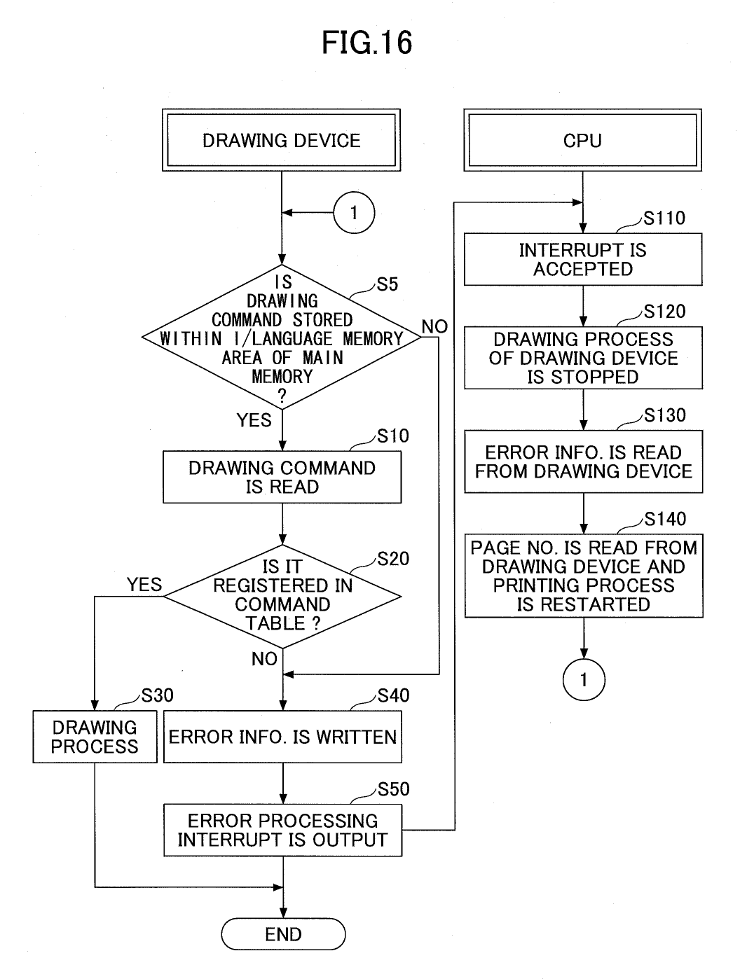

FIG. 16 is a flowchart for explaining a procedure in which a drawing process is performed by the drawing device of this embodiment. The procedure of FIG. 16 is essentially the same as the procedure of FIG. 12 except that step S5 is added.

As shown in FIG. 16, before reading a drawing command, the memory controller interface 101 determines, in step S5, whether the memory address output to the memory controller 48 is within the intermediate-language memory area of the main memory 110.

When the memory address is within the intermediate-language memory area (YES of S5), the drawing command is read from the memory and the detection of a command error etc. is performed similar to FIG. 12.

When the memory address is not in the intermediate-language memory area (NO of S5), the procedure progresses to step S40 and the remaining steps are performed similar to the embodiment of FIG. 12. Namely, the memory controller interface 101 writes the error information in step S40. The error processing command control module 107 reads the error processing command from the main memory 110 and performs the error processing function in step S50. The error processing command control module 107 notifies error detection to the controller 108 and the controller 108 interrupts the CPU 44 in step S50. After the step S50, operation of the drawing device 100 is controlled by the CPU 44.

In the foregoing description, the function of detecting both an address error of the embodiment of FIG. 16 and a command error of the embodiment of FIG. 12 is implemented in the drawing device 100. Alternatively, the function of detecting an address error only can be implemented in the drawing device 100.

As described above, according to the drawing device 100 of this embodiment, the detection range of an error is expandable.

As described in the foregoing, according to the image processing device of the present disclosure, it is possible to stop printing of an erroneous image when an error in the drawing command read from the memory is detected.

The image processing device according to the present disclosure which analyzes a drawing command read from the memory and writes, to the memory, image data obtained after the halftone processing function is performed is not limited to the specifically disclosed embodiments, and variations and modifications may be made without departing from the scope of the present disclosure.

The present application is based upon and claims the benefit of priority of the prior Japanese patent application No. 2011-177026, filed on Aug. 12, 2011, the contents of which are incorporated herein by reference in their entirety.

What is claimed is:

1. An image processing device which analyzes a drawing command read from a memory and performs a halftone processing function to image data, the image processing device comprising:
a drawing command analysis unit configured to analyze a drawing command read from the memory;
a drawing command table in which a full set of drawing commands is registered;
an error processing command storing unit in which an error processing command is stored;
an error processing executing unit configured to execute, when the drawing command analysis unit detects a command error indicating that the drawing command read from the memory is not registered in the drawing command table, the error processing command stored in the error processing command storing unit, so that an error processing function is performed.

2. The image processing device according to claim 1, further comprising a memory access unit configured to acquire an address of the drawing command from an external unit which is a source unit having written the drawing command to the memory, and configured to read the drawing command from a portion of the memory identified by the address,
wherein the memory access unit notifies the error processing executing unit of occurrence of an address error when the address of the drawing command is detected as going beyond a range of registered addresses of a drawing command memory area of the memory.

3. The image processing device according to claim 2, wherein, when a command error or an address error is detected, the error processing executing unit executes the error processing command stored in the error processing command storing unit, and selectively performs one of:
a function to replace the image data obtained after the halftone processing function with white pixels;
a function to invert black and white pixels of the image data obtained after the halftone processing function; and
a function to write pixels which form an error message to the memory.

4. The image processing device according to claim 2, further comprising an error information storing unit configured to store, when a command error or an address error is detected, identification information of the command error or the address error, and error information including the address of the memory where the drawing command is stored.

5. The image processing device according to claim 4, wherein the error information storing unit is further configured to store, when a command error is detected, the drawing command with which the command error is detected.

6. The image processing device according to claim 2, further comprising:
a page number counting unit configured to count a page number of a page with which a drawing processing function is being performed; and
an error notification unit configured to notify error detection to an external device when a command error or an address error is detected,
wherein the halftone processing function is restarted from a page with which the command error or the address error is detected in accordance with a request from the external device.

7. An image forming device including:
an image processing device;
a communication unit to communicate with a terminal device via a network, the terminal device transmitting print data to the image forming device;
a source unit to generate a drawing command from the print data received by the communication unit and to write the drawing command to a memory;
a printer engine to form an image on a printing medium; and
an engine controller to control the printer engine by receiving image data from the memory, which image data is written to the memory by the image processing device after a halftone processing function is performed,
wherein the image processing device comprises:
a drawing command analysis unit configured to analyze the drawing command read from the memory;
a drawing command table in which a full set of drawing commands is registered;
an error processing command storing unit in which an error processing command is stored;
an error processing executing unit configured to execute, when the drawing command analysis unit detects a command error indicating that the drawing command read from the memory is not registered in the drawing command table, the error processing command stored in the error processing command storing unit, so that an error processing function is performed.

8. An image processing method for use in an image processing device which analyzes a drawing command read from a memory and performs a halftone processing function to image data, the image processing method comprising:
analyzing, by a drawing command analysis unit of the image processing device, a drawing command read from the memory;
determining, by the drawing command analysis unit, whether the drawing command is registered in a drawing command table in which a full set of drawing commands is registered;
executing, by an error processing executing unit of the image processing device, an error processing command read from an error processing command storing unit when a command error is detected by the drawing command analysis unit, the command error indicating that the drawing command is not registered in the drawing command table, so that an error processing function is performed.
